(19) United States
(12) Patent Application Publication
(10) Pub. No.: US 2008/0084812 A1
(43) Pub. Date: Apr. 10, 2008

(54) Multilayer phase-change optical storage medium

(75) Inventors: Hiroshi Tabata, Yokohama-shi (JP); Shinji Higuchi, Yokohama-shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd. a corporation of Japan, Yokohama-Shi (JP)

(21) Appl. No.: 11/903,963

(22) Filed: Sep. 25, 2007

(30) Foreign Application Priority Data
Oct. 5, 2006 (JP) 2006-273715

(51) Int. Cl. G11B 7/24

(52) U.S. Cl. 369/275.1

(57) ABSTRACT

An optical storage medium has a substrate having a first surface and an opposite second surface, light being incident via the first surface in recording or reproduction and at least two composite layers formed on the second surface of the substrate, each composite layer having at least a recording film. At least one composite layer, except a composite layer farther or farthest from the first surface of the substrate, has at least a first protective film, an interface film, a semi-transparent recording film, a second protective film, a third protective film, and a semi-transparent reflective film formed in order when viewed from the substrate, the semi-transparent reflective film having a thickness below 10 nm, the first protective film, the interface film, the second protective film, and the third protective film having a relation σ2>σk>σ1≧σ3 in which σ1, σk, σ2, and σ3 denote thermal conductivity of the first protective film, the interface film, the second protective film, and the third protective film, respectively.

### CROSS-REFERENCE TO RELATED APPLICATIONS

This application is based on and claims the benefit of priority from the prior Japanese Patent Application No. 2006-273715 filed on Oct. 5, 2006, the entire content of which is incorporated herein by reference.

### BACKGROUND OF THE INVENTION

The present invention relates to a phase-change optical storage medium in or from which data is recorded, erased or reproduced with irradiation of a light beam (for example, a laser beam).

Phase-change optical storage media are data-rewritable storage media using a phenomenon of reversible change between the crystalline phase and the amorphous phase occurred in the material of a recording film by a light beam in recording or erasure. Representative of such media are recent CD-RW, DVD-RW, DVD-RAM, and BD-RE (Blu-ray Disc Rewritable). Especially, DVD-RW, DVD-RAM and BD-RE are used for recording and rewriting a large amount of data, such as video data.

A higher recording density could allow recording of a further large amount of data, a related technology being taught by Japanese Un-examined Patent Publication No. 2001-243655, disclosed in which is a multilayer optical storage medium having two or more of composite layers each composed of a recording film and a reflective film on one side of a substrate.

Such a multilayer optical storage medium with composite layers requires a higher transmittance for a composite layer located closer or closest to a laser-incident side of the storage medium than that or those located farther from the laser-incident side due to the fact that a laser beam is attenuated most when passing through the closer or closest composite layer. A higher transmittance discussed above requires a thinner film thickness of less than 10 nm for a recording film and/or a reflective film.

The inventors of the present invention produced a sample optical storage medium with such a closer or closest composite layer, discussed above, with the structure disclosed in Japanese Un-examined Patent Publication No. 5 (1993)-217211, having a film thickness of less than 10 nm for a recording film and a reflective film, aiming for a higher transmittance for the closer or closest composite layer. The sample, however, did not show acceptable recording and over-write characteristics.

### SUMMARY OF THE INVENTION

A purpose of the present invention is to provide a multilayer phase-change optical storage medium having two or more of composite layers each having a recording film and a reflective film, exhibiting excellent recording and over-write characteristics, with a composite layer located closer or closest to a laser-incident side of the storage medium, as discussed above, exhibiting a higher transmittance.

The present invention provides an optical storage medium comprising: a substrate having a first surface and an opposite second surface, light being incident via the first surface in recording or reproduction; and at least two composite layers formed on the second surface of the substrate, each composite layer having at least a recording film, wherein at least one composite layer, except a composite layer farther or farthest from the first surface of the substrate, has at least a first protective film, an interface film, a semi-transparent recording film, a second protective film, a third protective film, and a semi-transparent reflective film formed in order when viewed from the substrate, the semi-transparent reflective film having a thickness below 10 nm, the first protective film, the interface film, the second protective film, and the third protective film having a relation σ2>σk>σ1≧σ3 in which σ1, σk, σ2, and σ3 denote thermal conductivity of the first protective film, the interface film, the second protective film, and the third protective film, respectively.

### BRIEF DESCRIPTION OF DRAWINGS

FIG. 1 is an enlarged cross section illustrating an embodiment of a multilayer phase-change optical storage medium according to the present invention;

FIG. 2 is a view illustrating an example of a recording pulse sequence;

FIG. 3 is a Table 1 listing measured data of several samples of the optical storage medium according to the present invention;

FIG. 4 is a Table 2 listing measured data of several samples of the optical storage medium according to the present invention;

FIG. 5 is a Table 3 listing measured data of several samples of the optical storage medium according to the present invention;

FIG. 6 is a Table 4 listing measured data of several samples of the optical storage medium according to the present invention; and

FIG. 7 is a Table 5 listing measured data of several samples of the optical storage medium according to the present invention.

### DETAILED DESCRIPTION OF PREFERRED EMBODIMENT

[Structure of Optical Storage Medium]

Representative of an optical storage medium having two or more of composite layers each with a recording film of a phase-change material (referred to as a multilayer optical storage medium, hereinafter) are phase-change optical discs such as CD-RW, DVD-RW and BD-RE, and optical cards, media capable of repeatedly overwriting data.

Disclosed below as a preferred embodiment of the present invention is a multilayer optical storage medium D which is DVD-RW. Not only that, however, the present invention is applicable to other types of optical storage media such as BD-RE, having such a multilayer structure and recordable with a laser beam of a shorter wavelength than for DVD.

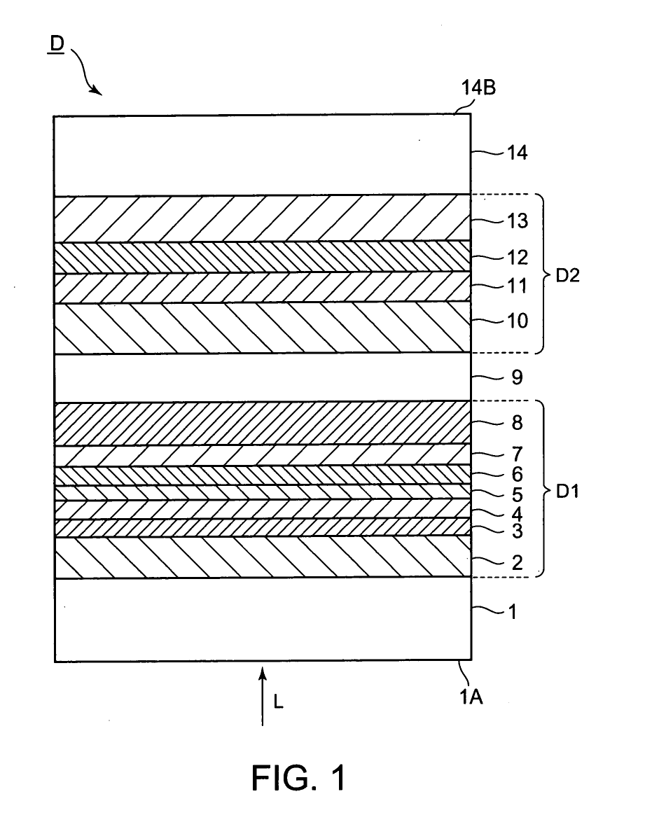

FIG. 1 is an enlarged sectional view of a multilayer optical storage medium D, a preferred embodiment of the present invention.

The optical storage medium D has a first composite layer D1 and a second composite layer D2. The first composite layer D1 is formed on a first substrate 1 having a bottom surface that is a light-incident surface 1A via which a laser beam L is incident in recording, reproduction or erasure. The second composite layer D2 is formed on a second substrate 14. The first and second composite layers D1 and D2 are laminated via an intermediate layer 9.

The first composite layer D1 is located closer to the laser-incident side (light-incident surface 1A) of the optical storage medium D. The second composite layer D2 is located farther from the laser-incident side of the optical storage medium D.

The first composite layer D1 consists of a first protective film 2, an interface film 3, a semi-transparent recording film 4, a second protective film 5, a third protective film 6, a semi-transparent reflective film 7, and an optical adjustment film 8, laminated in order on the first substrate 1.

The second composite layer D2 consists of a reflective film 13, a fifth protective film 12, a recording film 11, and a fourth protective film 10, laminated in order on the second substrate 14 having a labeling surface 14B.

The first and second composite layers D1 and D2 are bonded to each other via the intermediate layer 9 so that the optical adjustment film 8 (of the layer D1) and the fourth protective film 10 (of the layer D2) face each other.

Suitable materials for the first substrate 1 are several types of transparent synthetic resins, a transparent glass, and so on. The second substrate 14 may not be transparent due to the fact that recording or reproduction is performed to the second composite layer D2 from the light-incident surface 1A via the first composite layer D1. Nevertheless, the second substrate 14 may be made of the same material as the first substrate 1. Suitable materials for the substrates 1 and 14 in such use are, for example, glass, polycarbonate, polymethylmethacrylate, polyolefin resin, epoxy resin, and polyimide resin. Most suitable material is polycarbonate resin for low birefringence and hygroscopicity, and also easiness to process.

Although not limited, in compatibility with DVD or BD, the thickness of the first and second substrates 1 and 14 is preferably in the range from 0.01 mm to 0.7 mm (for the entire DVD or BD thickness of 1.2 mm). A highly recommended range is from 0.55 mm to 0.6 mm in compatibility with DVD and from 0.05 mm to 0.10 mm with BD.

A thickness of less than 0.01 mm is not feasible for the first substrate 1 because dust can easily affect recording with a converged laser beam incident via the light-incident surface 1A of the substrate 1. A range from 0.01 mm to 5 mm may be acceptable for practical use if the optical storage medium D has no limitation for its entire thickness. A thickness over 5 mm makes it difficult to raise the numerical aperture of an objective lens to be used in recording or reproduction to or from the optical storage medium D, which inevitably causes a larger spot size for a laser beam, thus resulting in difficulty in raising recording density. Such a thickness over 5 mm is thus not preferable for the optical storage medium D of the present embodiment provided with plural composite layers for higher recording density.

The substrates 1 and 14 may be flexible or rigid. Flexible substrates 1 and 14 may be used for tape-, sheet- or card-type optical storage media whereas rigid substrates 1 and 14 for card- or disk-type optical storage media.

The first protective film 2, the third protective film 6, the fourth protective film 10, and the fifth protective film 12 protect the first substrate 1, the semi-transparent recording film 4, the recording film 11, etc., against deformation due to heat which may otherwise cause poor recording characteristics, and enhance contrast of reproduced signals by means of optical interference.

It is preferable for the first protective film 2, the third protective film 6, the fourth protective film 10, and the fifth protective film 12 to allow a laser beam to pass therethrough in recording, reproduction or erasure, with a refractive index “n” in the range of 1.9≦n≦2.3. A suitable material for these protective films is a material that exhibits high thermal characteristics, for example, an oxide such as SiO₂, SiO, ZnO, TiO₂, Ta₂O₅, Nb₂O₅, ZrO₂ and MgO, a sulfide such as ZnS, In₂S₃ and TaS₄, and carbide such as SiC, TaC, WC and TiC, or a mixture of these materials. A material including at least either ZnS or SiO₂ is more suitable for these protective films. These protective films may or may not be made of the same material or composition. A mixture of ZnS and SiO₂ is the best for high recording sensitivity, C/N and erasing rate against repeated recording, reproduction or erasure. A feasible mixing ratio of SiO₂ to ZnS is in the range from 5% to 50%.

The recording sensitivity defined as a degree of reversible change in which a recording film changes between the crystalline phase and the amorphous phase, depending on the power of a laser beam L, in the present invention. A highly recording-sensitive recording film is excellent in recording or erasure even with a low-power laser beam, according to the definition.

The thickness of the first and fourth protective films 2 and 10 is in the range from about 5 nm to 500 nm, preferably, 20 nm to 300 nm so that they cannot be easily peeled off from the first substrate 1, the semi-transparent recording film 4, the intermediate film 9 or the recording film 11, and are not prone to damages such as cracks. The thickness below 20 nm can hardly offer high optical characteristics whereas over 300 nm prone to cracks or peeling off, thus causing lower productivity.

A highly recommended range for the first protective film 2 is from 40 nm to 80 nm for higher optical contrast and transmittance. A highly recommended range for the fourth protective film 10 is from 100 nm to 170 nm for higher reflectivity. Moreover, the fourth protective film 10 may be composed of plural materials of different refractive indices for higher reflectivity.

The thickness of the third and fifth protective films 6 and 12 is, preferably, in the range from 0.5 nm to 50 nm for higher recording characteristics such as C/N and erasing rate, and also higher stability in a number of repeated overwriting. The thickness below 0.5 nm can hardly give enough heat to the semi-transparent recording film 4 and the recording film 11, resulting in increase in optimum recording power for acceptable C/N and erasing rate. In contrast, the thickness over 50 nm gives heat too much to the semi-transparent recording film 4 and the recording film 11 and causes thermal damage to them, resulting in poor C/N or erasing characteristics in overwriting.

A highly recommended range for the third protective film 6 is from 2 nm to 10 nm, otherwise the film 6 can hardly give off heat due to the existence of the semi-transparent reflective film 7. A highly recommended range for the fifth protective film 12 is from 20 nm to 40 nm so that the semi-transparent recording film 4 becomes highly sensitive.

One requirement for the interface film 3 is that it is made of a material without including a sulfide. An interface film made of a material including a sulfide suffers diffusion of the sulfide into the semi-transparent recording film 4 when subjected to repeated overwriting, which could lead to poor recording characteristics.

An acceptable material for the interface film 3 includes at least any one of a nitride, an oxide and a carbide, specifically, germanium nitride, silicon nitride, aluminum nitride, aluminum oxide, zirconium oxide, chromium oxide, silicon carbide and carbon. Oxygen, nitrogen or hydrogen may be added to the material of the interface layer. The nitride, oxide and carbide listed above may not be stoichiometric compositions for such an interface film. In other words, nitrogen, oxygen or carbon may be excessive or insufficient.

In the case of nitride, it is preferable for the interface film 3 to be composed of a material including at least GeN or SiN. In the case of oxide, it is preferable for the interface film 3 to be composed of a material including at least one from among Ta₂O₅, Nb₂O₅, ZrO₂, TiO₂, and Al₂O₃.

Moreover, it is preferable for the interface film 3 to be composed of a material including any one listed above as a major component. The term “major component” in this invention is defined as a component, from among those listed above, having a percentage of 50% or higher, preferably, 90% or higher, in all of the components of the interface film 3.

Moreover, it is preferable for the interface film 3 to be composed of a material that exhibits a high melting point so as not to be melted with the semi-transparent recording film 4 that exhibits a high temperature in recording.

The semi-transparent recording film 4 and recording film 11 are a film of an alloy of Sb—Te added with at least any one of Ag, Si, Al, Ti, Bi, Ga, In and Ge, or of Ge—Sb with at least any one of In, Sn and Bi. It is preferable for the interface film 3 to be composed of GeN when the recording film 4 is composed of the alloy of Sb—Te as the major component. The recording films 4 and 11 may be or may not be made of the same material or composition.

A preferable thickness for the semi-transparent recording film 4 is from 3 nm to 10 nm. The thickness below 3 nm lowers the crystallization speed which causes poor recording characteristics whereas over 10 nm causes lower transmittance to the first composite layer D1. A preferable thickness for the recording film 11 is from 10 nm to 25 nm. The thickness below 10 nm lowers optical absorption rate to cause difficulty in giving off heat, thus resulting in poor recording characteristics whereas over 25 nm requires a larger laser power in recording.

Another interface film (not shown) may be provided on the light-incident surface 1A side of the recording film 11 or on both sides thereof. Such an interface film is preferably composed of the same material as the counterpart 3.

The present embodiment employs the semi-transparent reflective film 7 made as thin as possible (less than 10 nm) so that the first composite layer D1 exhibits a higher transmittance. Such a thin reflective film 7 tends to cause the semi-transparent recording film 4 to be heated without giving heat off enough, thus not to be cooled enough.

There is a possible solution for the semi-transparent recording film 4 so that the film 4 can smoothly give off heat. It is use of materials that exhibit a higher thermal conductivity than the recording film 4 to the films provided between the film 4 and the semi-transparent reflective film 7.

Nevertheless, the materials that exhibit only such a high thermal conductivity for the films between the semi-transparent recording film 4 and the semi-transparent reflective film 7 cause that the film 4 cannot keep heat enough for recording, which leads to imperfect recorded marks (amorphous marks), resulting in lower intensity of signals (signal intensity, hereinafter) when reproduced from the optical storage medium D, and hence in poor recording characteristics.

The present embodiment employs a specific material that exhibits a high thermal conductivity for the second protective film 5 and another specific material that exhibits a lower thermal conductivity than the former material for the third protective film 6, between the semi-transparent recording film 4 and the semi-transparent reflective film 7, so that the film 4 can keep heat well and then give it off well in a balanced manner for excellent recording characteristics.

It is preferable for the second protective film 5 to be made of a material that exhibits a higher thermal conductivity than for the third protective film 6, and also than for the first protective film 2 and the interface film 3.

A feasible material for the second protective film 5 is aluminum nitride, silicon carbide, or a mixture of either of them as a major component. A more feasible material is silicon carbide without including nitrogen or a mixture of silicon nitride as a major component and an oxide. The major component in this case is defined as a component, from among those listed above, having a percentage of 50% or higher, preferably, 90% or higher, in all of the components of the protective film 5.

The thickness of the second protective film 5 is preferably in the range from 1 nm to 10 nm, which depends on the thermal conductivity and refractive index of the material to be used for the film 5. The thickness below 1 nm causes poor recording and overwrite characteristics. The thickness over 10 nm prevents the semi-transparent recording film 4 from giving heat off enough, resulting in weaker signal length. A recommended thickness of the second protective film 5 is smaller than 5 nm, particularly, from 2 nm to 4 nm when a mixture of ZnS and ZnO₂ is employed for the first and third protective films 2 and 6. Such a thickness of the second protective film 5 allows the semi-transparent recording film 4 to keep heat well and then give it off well in a balanced manner, with asymmetry of reproduced signals being restricted well from varying depending on the number of overwriting.

One requirement for the first protective film 2, the interface film 3, the second protective film 5, and the third protective film 6 is that each film has a melting point of 1500° C. or higher so that a composition of each film is not melted and mixed with that of the semi-transparent recording film 4. The material of each film preferably has an extinction coefficient of 1 or smaller which allows the first composite layer D1 to have a higher transmittance to a laser beam L in recording to or reproduction from the second composite layer D2.

Preferable materials for the semi-transparent reflective film 7 and the reflective film 13 are a metal (that exhibits reflectivity), such as Al, Au and Ag, an alloy of any of these metals, as a major component, with at least one type of metal or semiconductor, and a metal nitride, a metal oxide or a metal chalcogen of Al, Si, etc. The major component here is a metal, such as Al, Au and Ag that exceeds 50% or, preferably, 90% in all of the components of the reflective films 7 and 13.

Most preferable among them is a metal, such as Au and Ag, and also an alloy of either of the metals as a major component, for high reflectivity and thermal conductivity. A typical alloy is made of Al and at least one of the following elements: Si, Mg, Cu, Pd, Ti, Cr, Hf, Ta, Nb, Mn, Zr, etc., or Au or Ag and at least one of the following elements: Cr, Ag, Cu, Pd, Pt, Ni, Nd, In, etc. For high linear velocity recording, the most preferable one is a metal or an alloy having Ag exhibiting extremely high thermal conductivity, as a major component, in view of recording characteristics. Recommended most is Au or Ag having a refractive index of smaller than 1 that gives a higher transmittance to the semi-transparent reflective film 7 to the wavelength of a laser beam in recording.

A preferable thickness range for the semi-transparent reflective film 7 is from 3 nm to 10 nm, which depends on the thermal conductivity of a material used for this film. The reflective film 7 having a thickness of smaller than 3 nm cannot absorb enough heat given off by the semi-transparent recording film 4, thus the film 4 cannot be rapidly cooled down, resulting in poor recording characteristics. The thickness over 10 nm causes decrease in transmittance of the first composite layer D1.

A preferable thickness range for the reflective film 13 is from 50 nm to 300 nm, which also depends on the thermal conductivity of a material used for this film. The reflective film 13 of 50 nm or more in thickness is optically stable in, particularly, reflectivity. Nevertheless, a thicker reflective film affects a cooling rate. Thickness over 300 nm requires a longer production time. A material exhibiting a high thermal conductivity allows the reflective film 13 to have a thickness in an optimum range such as mentioned above.

Any film that touches the semi-transparent reflective film 7 or the reflective film 13 is preferably made of a material without sulfur when the film 7 or 13 is made of pure silver or an alloy of silver, so as not to produce a compound of AgS that leads to higher error rate.

A diffusion prevention film (not shown) is, preferably, provided between the third protective film 6 and the semi-transparent reflective film 7 and/or between the fifth protective film 12 and the reflective film 13. Such a prevention film is useful when the reflective film 7 and/or 13 are/is made of Ag or an alloy of Ag and the protective film 6 and/or 12 are/is made of a mixture of ZnS. Because the prevention film restricts decrease in reflectivity due to generation of a compound of AgS due to chemical reaction between S in the protective film 6 and/or 12 and Ag in the reflective film 7 and/or 13.

One requirement for the material of the diffusion prevention film is that it is made of a material without sulfur, like the interface film 3 described above. Preferable materials for the diffusion prevention film are metals, semiconductors, silicon nitride, germanium nitride and germanium chrome nitride, in addition to those the same as the interface film 3.

Preferable materials for the optical adjustment film 8 are those that exhibit a higher refractive index than the semi-transparent reflective film 7 and an extinction coefficient smaller than 1, to enhance the transmittance of the first composite layer D1. The thickness of the film 8 is adjusted so that the layer D1 exhibits higher transmittance in relation to the refractive index of the film 8, wavelength of a laser beam to pass therethrough, etc. A preferable thickness for the film 8 is in the range from 40 nm to 60 nm or 190 nm to 210 nm to a laser wavelength of 660 nm when the film 8 has a refractive index of 2.1.

A preferable material for the optical adjustment film 8 is, an oxide such as SiO₂, SiO, ZnO, TiO₂, Ta₂O₅, Nb₂O₅, ZrO₂, or MgO, a sulfide such as ZnS, In₂S₃ or TaS₄, or carbide such as SiC, TaC, WC or TiC, or a mixture of any of these oxides, sulfides or carbides, for their comparatively higher refractive index. Among them, a mixture of ZnS and SiO₂ is the most recommendable for higher sputtering rate and thus higher productivity.

[Optical Storage Medium Production Method]

Lamination of the several films shown in FIG. 1 on the first or the second substrate 1 or 14 is achieved by any known vacuum thin-film forming technique, such as, vacuum deposition (with resistive heating or electron bombardment), ion plating, (D.C., A.C. or reactive) sputtering. The most feasible among the techniques is sputtering for easiness of composition and film-thickness control.

A film-forming system feasible in this method is a batch system in which a plural number of substrates are simultaneously subjected to a film forming process in a vacuum chamber or a single-wafer system in which substrates are processed one by one. The thickness of each film can be adjusted with control of power to be supplied and its duration in sputtering or monitoring conditions of deposited films with a crystal oscillator.

These films can be formed while each substrate is being stationary, transferred or rotating. Rotation of the substrate (and further with orbital motion) is most feasible for higher uniformity. An optional cooling process to the first and second substrates 1 and 14 minimizes warpage of the substrates, depending on heat generated during the film forming process.

A first production method for producing the optical storage medium D is to: form the first protective film 2, the interface film 3, the semi-transparent first recording film 4, the second protective film 5, the third protective film 6, the semi-transparent reflective film 7, and the optical adjustment film 8 in order on the first substrate 1 to produce the first composite layer D1, with the film forming technique described above; form the reflective film 13, the fifth protective film 12, the recording film 11, and the fourth protective film 10 in order on the second substrate 14 to produce the second composite layer D2, with the film forming technique described above; and bond the first and second layers D1 and D2 with the intermediate layer 9 made of an adhesive sheet or a UV-curable resin. The layers D1 and D2 may be produced at the same time or either can be produced first.

A second production method for producing the optical storage medium D is to: form the first protective film 2, the interface film 3, the semi-transparent recording film 4, the second protective film 5, the third protective film 6, the semi-transparent reflective film 7, and the optical adjustment film 8 in order on the first substrate 1 to produce the first composite layer D1, with the film forming technique described above; apply a UV-curable resin on the layer D1 (on the film 8); harden or cure the resin with UV rays while a clear stamper (for groove transfer) is being attached on the resin to form the intermediate layer 9; after detaching the stamper, form the fourth protective film 9, the recording film 11, the fifth protective film 12, and the reflective film 13 in order on the intermediate layer 9 to produce the second composite layer D2, with the film forming technique described above; and bond the second substrate 14 to the second layer D2 with an adhesive sheet or a UV-curable resin.

The first production method is more feasible than the second production method for higher mass productivity.

The optical storage medium D produced as described above is initialized in such a way that the semi-transparent recording film 4 and the recording film 11 are exposed to a laser beam, light of a xenon flash lamp, etc., so that the materials of the films 4 and 11 are heated to be crystallized. Initialization with a laser beam is preferable for less noise in reproduction.

[Study of Thermal Conductivity]

Several embodiment and comparative sample optical storage media were produced with the semi-transparent reflective film 7 having a thickness smaller than 10 nm in order to achieve higher transmittance at the first composite layer D1 located closer to the light-incident surface 1A in the optical storage medium D of the embodiment of the present invention.

Examined on the sample optical storage media were requirements of the first protective film 2, the interface film 3, the second protective film 5, and the third protective film 6, that give excellent recording and overwrite characteristics to the semi-transparent recording film 4.

The thermal conductivity of the first, second and third protective films 2, 5 and 6, and the interface film 3 was measured for each sample optical storage medium as follows:

Samples were produced each with a material the same as the respective films 2, 3, 5 and 6, and formed on a silicon substrate, as having a thickness of 200 nm, by sputtering. The thermal conductivity was measured for each sample with the 2ω-method nano-thin-film thermal-conductivity measuring instrument (TCN-2ω) made by ULVAC-RIKO, Inc.

Recording was then conducted with an optical-disc drive unit (ODU1000) made by Pulstec. Industrial Co., Ltd., to the semi-transparent recording film 4 of the first composite layer D1 for each sample optical storage medium, at 7.7 m/s in recording linear velocity (corresponding to ×2 speed in dual-layer DVD-ROM specifications) with an 8-16 (EFM⁺) modulation random pattern, in the same density as DVD-ROM, and as having 0.440 μm in the shortest mark length. Under the recording, storage capacity of the optical disc D in the present embodiment corresponds to 8.5 gigabytes for the two recording films.

Recording of 0-, 1-, 10-, and 1000-time overwriting was conducted to a target track and adjacent tracks on each sample under the optimum recording conditions, followed by slicing at the amplitude center of each reproduced signal for measurements of clock to data jitters. The power of a laser beam was constant at 1.4 mW in reproduction from each sample.

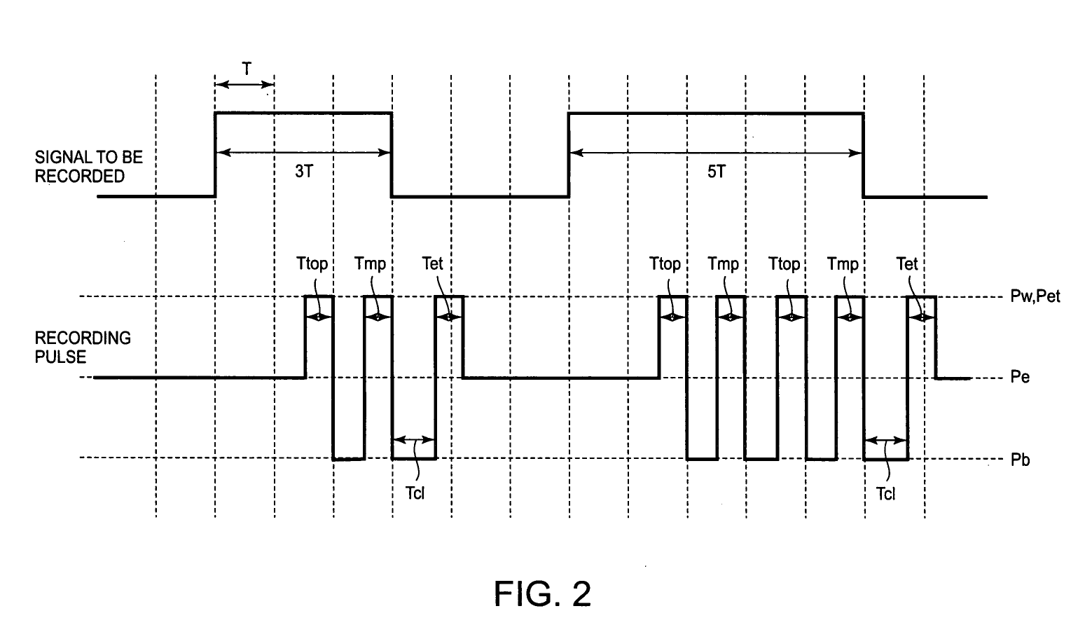

Recording pulse sequences shown in FIG. 2 were used in the write strategy. Each recording pulse sequence consists of several 1T-multipulses followed by an erasing Top pulse Tet. Moreover, Each recording pulse sequence consists of a top pulse Ttop that rises from an erasing power Pe to a recording power Pw at which a laser beam is emitted onto a recording film and multipulses Tmp, that follow the top pulse Ttop, for alternatively applying the recording power Pw and a bottom power Pb, with a cooling pulse Tcl that rises from the bottom power Pb to the erasing power Pe, followed by an erasing Top pulse Tet for applying an erasing top power Pet. The erasing Top pulse Tet is located at the end of each sequence for each recorded mark. The top pulse Ttop and the multipulses Tmp constitute a heating (recording) pulse sequence for forming a recorded mark on a recording film. A recording pulse may be formed only with the top pulse Ttop with no multipulses Tmp. The term “multipulse Tmp” does not necessarily mean a plurality of pulses, or it may mean a single pulse, as shown in FIG. 2, in this disclosure.

Recording parameters were: a recording power Pw=23.0 [mW], an erasing power Pe=4.6 [mW], a bottom power Pb=0.0 [mW], and an erasing top power Pet=23.0 [mW], with a top pulse Ttop=0.23 [T], a multipulse Tmp=0.23 [T], a cooling pulse Tcl=0.73 [T], and an erasing top pulse Tet=0. 23 [T].

Recording was conducted to the semi-transparent recording film 4 with the multipulse sequences, the number of pulses being increased or decreased according to desired mark length, modulated with laser strength of four levels (the recording power Pw, erasing power Pe, bottom power Pb, and erasing top power Pet).

Evaluated for the embodiment and comparative sample optical storage media were the recording and overwrite characteristics of the first composite layer D1 closer to the light-incident surface 1A for a laser beam L, which will be discussed below.

### Embodiment Sample 1

Several films which will be disclosed later, were formed on a first substrate 1 made of a polycarbonate resin with 120 mm in diameter and 0.6 mm in thickness. Grooves were formed on the substrate 1 at 0.74 μm in track pitch, with 25 nm in groove depth and about 50:50 in width ratio of groove to land. The grooves stuck out when viewed from an incident direction of a laser beam L.

After a vacuum chamber was exhausted up to 3×10⁻⁴ Pa, a 70-nm-thick first protective film 2 was formed on the first substrate 1 by high-frequency magnetron sputtering with a target of ZnS added with 20-mol % SiO₂ at 2×10⁻¹ Pa in Ar-gas atmosphere.

Formed on the first protective film 2, in order, were a 2-nm-thick interface film 3 by high-frequency magnetron sputtering with a target of Ge in a mixed-gas atmosphere of Ar and N gases (at a flow rate of 3:7 for Ar and N), an 8-nm-thick semi-transparent recording film 4 with a target of an alloy of 4 elements Ag—In—Sb—Te, a 2-nm-thick second protective film 5 with a target of SiC, a 7-nm-thick third protective film 6 of the same material as the first protective film 2, a 7-nm-thick semi-transparent reflective film 7 with a target of an alloy of 3 elements Ag—Pd—Cu, and a 60-nm-thick optical adjustment film 8 of the same material as the first protective film 2, thus a first composite layer D1, such as shown in FIG. 1, was produced.

Formed in order on a second substrate 14, produced in the same manner as the first substrate 1, by sputtering with the same requirements as the first composite layer D1, were a 90-nm-thick reflective film 13 of the same material as the semi-transparent reflective film 7, a 30-nm-thick fifth protective film 12 of the same material as the first protective film 2, a 20-nm-thick recording film 11 of the same material as the semi-transparent recording film 4, and a 140-nm-thick fourth protective film 10 of the same material as the first protective film 2, thus a second composite layer D2, such as shown in FIG. 1, was produced.

The optical adjustment film 8 of the first composite layer D1 was spin-coated with an acrylic ultraviolet-cured resin (SD661® made by Dainippon Ink & Chemical Inc.). The resin was cured with radiation of ultraviolet rays so that a 50-μm-thick intermediate film 9 was formed on the optical adjustment film 8. The first and second composite layers D1 and D2 were bonded to each other so that the optical adjustment film 8 and the fourth protective film 10 faced each other, thus an optical storage medium D, such as shown in FIG. 1, was produced.

The optical storage medium D produced as above was exposed to a wide beam, a width thereof in a direction of tracks on the medium D being wider than another width thereof in a direction of radius of the medium D, so that the semi-transparent recording film 4 and the recording film 11 were heated to a crystallization temperature or higher for initialization.

Data was then recorded onto the semi-transparent recording film 4 on the grooves with a focused laser beam L via the light-incident surface 1A of the first composite layer D1.

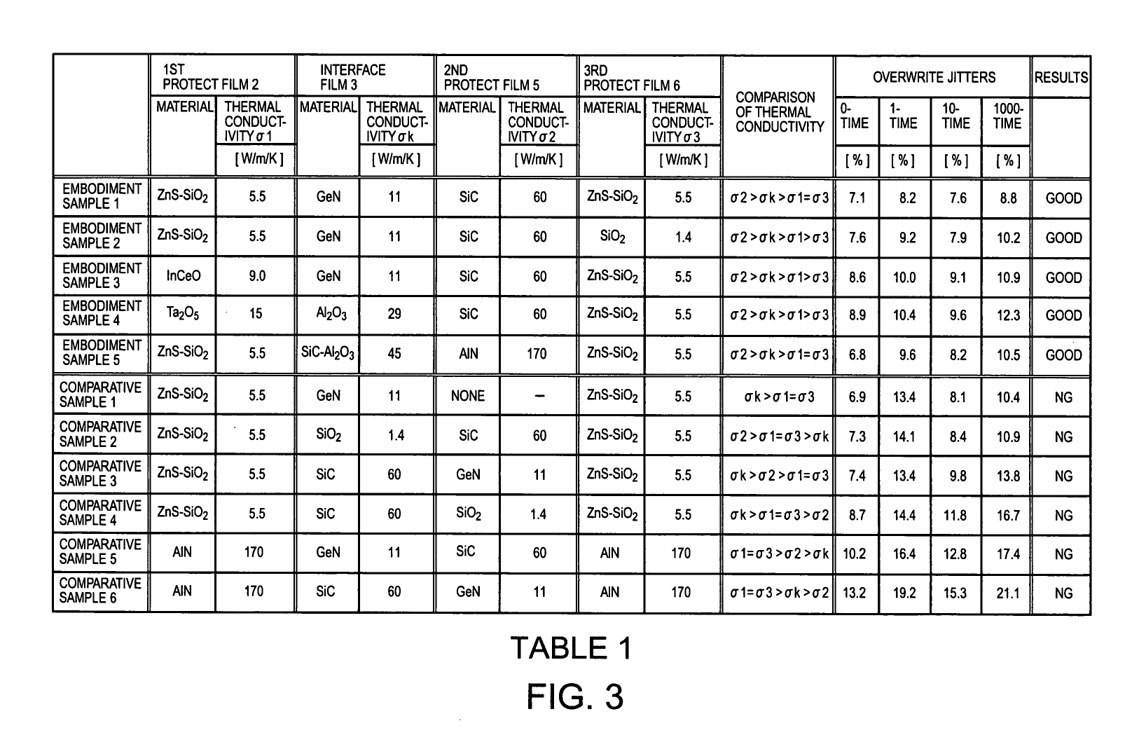

Measured results were as shown in Table 1 of FIG. 3 for the embodiment sample 1, which lists thermal conductivity of a material of each listed film and jitters in 0-, 1-, 10-, and 1000-time overwriting.

Defined in the evaluation is “excellent” in jitters of 13.0 or less that is the maximum allowable level at which the recorded data can be reproduced at a lower error rate. In results in Table 1, the item GOOD is given to the sample optical storage media that exhibited jitters of 13.0 or less in all of the 0-, 1-, 10-, and 1000-time overwriting whereas the item NG given to the samples that exhibited jitters over 13.0 even in any one of the 0-, 1-, 10-, and 1000-time overwriting.

The results of the other embodiment and comparative samples under the same measurements as the embodiment sample 1 are also shown in Table 1 of FIG. 3.

Measured results for the embodiment sample 1 were: 5. W/m/K in thermal conductivity σ1 of the first protective film 1 formed with a target of ZnS added with SiO₂ in 20 mol %; 5.5 W/m/K in thermal conductivity σ3 of and the third protective film 3 formed with a target of ZnS added with SiO₂ in 20 mol %; 11 W/m/K in thermal conductivity σk of the interface film 3 formed with a target of Ge in a mixed-gas atmosphere of Ar and N gases; and 60 W/m/K in thermal conductivity σ2 of the second protective film 5 formed with a target of SiC, having a relation of σ2>σk>π1=σ3.

Other measured results were: 7.1%, 8.2%, 7.6% and 8.8% in the 0-, 1-, 10-, and 1000-time overwriting, respectively, below 13.0%, excellent in the recording and overwrite characteristics.

### Embodiment Sample 2

The optical storage medium D in the embodiment sample 2 was identical to that of the embodiment sample 1 except for a 4-nm-thick third protective film 6 formed with a target of SiO₂.

Measured results in thermal conductivity in the embodiment sample 2, different from the embodiment sample 1, were 1.4 W/m/K in thermal conductivity σ3 of the third protective film 6, with a relation of σ2>σk>σ1>σ3 among the listed films.

Other measured results were: 7.6%, 9.2%, 7.9% and 10.2% in the 0-, 1-, 10-, and 1000-time overwriting, respectively, below 13.0%, excellent in the recording and overwrite characteristics.

### Embodiment Sample 3

The optical storage medium D in the embodiment sample 3 was identical to that of the embodiment sample 1 except for the first protective film 2 formed with a target of InCeO at an optimum film thickness.

The expression “an optimum film thickness” is defined as a thickness that causes the smallest jitters in this embodiment.

Measured results in thermal conductivity in the embodiment sample 3, different from the embodiment sample 1, were 9.0 W/m/K in thermal conductivity σ1 of the first protective film 2, with a relation of σ2>σk>σ1>σ3 among the listed films.

Other measured results were: 8.6%, 10.0%, 9.1% and 10.9% in the 0-, 1-, 10-, and 1000-time overwriting, respectively, below 13.0%, excellent in the recording and overwrite characteristics.

### Embodiment Sample 4

The optical storage medium D in the embodiment sample 4 was identical to that of the embodiment sample 1 except for the first protective film 2 formed with a target of Ta₂O₅ at an optimum film thickness and the interface film 3 formed with a target of Al₂O₃ at an optimum film thickness.

Measured results in thermal conductivity in the embodiment sample 4, different from the embodiment sample 1, were 15 W/m/K in thermal conductivity σ1 of the first protective film 2 and 29 W/m/K in thermal conductivity σk of the interface film 3, with a relation of σ2>σk>σ1>σ3 among the listed films.

Other measured results were: 8.9%, 10.4%, 9.6% and 12.3% in the 0-, 1-, 10-, and 1000-time overwriting, respectively, below 13.0%, excellent in the recording and overwrite characteristics.

### Embodiment Sample 5

The optical storage medium D in the embodiment sample 5 was identical to that of the embodiment sample 1 except for the interface film 3 formed with a target of SiC—Al₂O₃ at an optimum film thickness and the second protective film 5 formed with a target of AlN at an optimum film thickness.

Measured results in thermal conductivity in the embodiment sample 5, different from the embodiment sample 1, were 45 W/m/K in thermal conductivity σk of the interface film 3 and 170 W/m/K in thermal conductivity σ2 of the second protective film 5, with a relation of σ2>σk>σ1=σ3 among the listed films.

Other measured results were: 6.8%, 9.6%, 8.2% and 10.5% in the 0-, 1-, 10-, and 1000-time overwriting, respectively, below 13.0%, excellent in the recording and overwrite characteristics.

### Comparative Sample 1

The optical storage medium D in the comparative sample 1 was identical to that of the embodiment sample 1 except that the second protective film 5 was not formed.

Measured results in thermal conductivity in the comparative sample 1, different from the embodiment sample 1, were no thermal conductivity σ2 being measured, with a relation of σk>σ1=σ3 among the listed films.

Other measured results were: 6.9%, 13.4% (over 13.0%), 8.1% and 10.4% in the 0-, 1-, 10-, and 1000-time overwriting, respectively, poor in the overwrite characteristics.

### Comparative Sample 2

The optical storage medium D in the comparative sample 2 was identical to that of the embodiment sample 1 except for the interface film 3 formed with a target of SiO₂ at an optimum film thickness.

Measured results in thermal conductivity in the comparative sample 2, different from the embodiment sample 1, were 1.4 W/m/K in thermal conductivity σk of the interface film 3, with a relation of σ2>σ1=σ3>σk among the listed films.

Other measured results were: 7.30%, 14.1% (over 13.0%), 8.4% and 10.90% in the 0-, 1-, 10-, and 1000-time overwriting, respectively, poor in the overwrite characteristics.

### Comparative Sample 3

The optical storage medium D in the comparative sample 3 was identical to that of the embodiment sample 1 except for the interface film 3 formed with a target of SiC at an optimum film thickness and the second protective film 5 formed with a target of Ge in a mixed-gas atmosphere of Ar and N gases at an optimum film thickness.

Measured results in thermal conductivity in the comparative sample 3, different from the embodiment sample 1, were 60 W/m/K in thermal conductivity σk of the interface film 3 and 11 W/m/K in thermal conductivity σ2 of the second protective film 5, with a relation of σk>σ2>σ1=σ3 among the listed films.

Other measured results were: 7.40%, 13.40% (over 13.0%), 9.8% and 13.8% (over 13.0%) in the 0-, 1-, 10-, and 1000-time overwriting, respectively, poor in the overwrite characteristics.

### Comparative Sample 4

The optical storage medium D in the comparative sample 4 was identical to that of the embodiment sample 1 except for the interface film 3 formed with a target of SiC at an optimum film thickness and the second protective film 5 formed with a target of SiO₂ at an optimum film thickness.

Measured results in thermal conductivity in the comparative sample 4, different from the embodiment sample 1, were 60 W/m/K in thermal conductivity σk of the interface film 3 and 1.4 W/m/K in thermal conductivity σ2 of the second protective film 5, with a relation of σk>σ1=σ3>σ2 among the listed films.

Other measured results were: 8.7%, 14.4% (over 13.0%), 11.8% and 16.7% (over 13.0%) in the 0-, 1-, 10-, and 1000-time overwriting, respectively, poor in the overwrite characteristics.

### Comparative Sample 5

The optical storage medium D in the comparative sample 5 was identical to that of the embodiment sample 1 except for the first protective film 2 formed with a target of AlN at a thickness of 100 nm and the third protective film 6 formed with a target of AlN at a thickness of 12 nm.

Measured results in thermal conductivity in the comparative sample 5, different from the embodiment sample 1, were 170 W/m/K in thermal conductivity σ1 and σ3 of the first and third protective films 2 and 6, respectively, with a relation of σ1=σ3>σ2>σk among the listed films.

Other measured results were: 10.2%, 16.4% (over 13.0%), 12.8% and 17.4% (over 13.0%) in the 0-, 1-, 10-, and 1000-time overwriting, respectively, poor in the overwrite characteristics.

### Comparative Sample 6

The optical storage medium D in the comparative sample 6 was identical to that of the embodiment sample 1 except for the first protective film 2 formed with a target of AlN at a thickness of 100 nm, the interface film 3 formed with a target of SiC at an optimum film thickness, the second protective film 5 formed with a target of Ge in a mixed-gas atmosphere of Ar and N gases at an optimum film thickness, and the third protective film 6 formed with a target of AlN at a thickness of 12 nm.

Measured results in thermal conductivity in the comparative sample 6, different from the embodiment sample 1, were 170 W/m/K in thermal conductivity σ1 and σ3 of the first and third protective films 2 and 6, respectively, 60 W/m/K in thermal conductivity σk of the interface film 3, and 11 W/m/K in thermal conductivity σ2 of the second protective film 5, with a relation of σ1=σ3>σk>σ2 among the listed films.

Other measured results were: 13.2%, 19.2%, 15.3% and 21.1% in the 0-, 1-, 10-, and 1000-time overwriting, respectively, over 13.0%, poor in the overwrite characteristics.

Table 1 in FIG. 3 teaches the following, according to the measured results of the embodiment samples 1 to 5 and the comparative samples 1 to 6.

According to the results of the embodiment samples 1 to 5, it is found that a jitter level is acceptable when the first, second and third protective films 2, 5 and 6, and the interface film 3 have a relation among their thermal conductivity σ1, σ2, σ3 and σk, respectively, such that σ2 is the highest, σk is next to σ2, and σ1 and σ3 are lower than σk. It is also found that a jitter level is still acceptable as long as σ2 is the highest followed by σk, with σ1 higher than or equal to σ3, which is expressed as σ2>σk>σ1>σ3. This relation is expressed as σ2>σk>(σ1, σ3), hereinafter.

In contrast, according to the results of the comparative samples 1 to 6, the optical storage medium D of the comparative sample 1, with the third protective film 6 only between the semi-transparent recording film 4 and the semi-transparent reflective film 7 without the second protective film 5 therebetween, suffered jitters over 13.0% in the 1-time overwriting, thus exhibited poor overwrite characteristics. The comparative samples 2 to 6 also exhibited poor overwrite characteristics because they did not satisfy the relation σ2>σk>(α1, σ3).

A possible reason for the adverse results of the comparative samples 1 to 6 lies in light absorption, at the time of 1-time overwriting, which depends on whether a zone on the semi-transparent recording film 4 to be overwritten with data is already in the amorphous phase with a recorded mark already formed thereon or the crystalline phase. The semi-transparent recording film 4 exhibits higher light absorption in the crystalline phase than in the amorphous phase and also a higher maximum constant temperature in the former phase than the latter when heated by a laser beam L. Also different between the amorphous and crystalline phases is a cooling rate at which the semi-transparent recording film 4 is cooled down from the moment of termination of laser emission.

Difference in maximum constant temperature between the amorphous and crystalline phases of the zone to be overwritten in the semi-transparent recording film 4 causes distortion to a recorded mark formed by overwriting (overwrite distortion).

Since the comparative samples 1 to 6 did not satisfy the relation σ2>σk>(σ1, σ3), the semi-transparent recording film 4 could not keep heat well and then give it off well in a balanced manner and hence could not cancel the overwrite distortion, thus suffered poor overwrite characteristics in the 1-time overwriting.

As discussed above, when the films of the first composite layer D1 of the optical storage medium D are formed so that they satisfy the relation σ2>σk>(σ1, σ3), the semi-transparent recording film 4 can keep heat well and then give it off well in an optimum balanced manner and hence can cancel the overwrite distortion, to form desired size of recorded marks, thus exhibiting excellent recording and overwrite characteristics.

The evaluation is done as discussed above for the embodiment samples 1 to 5 and the comparative samples 1 to 6 that were dual-layer DVD-RWs as the multilayer phase-change optical storage media. However, not only the dual-layer type, but also phase-change optical storage media having three or more of composite layers can enjoy such excellent recording and overwrite characteristics when semi-transparent composite layers except the composite layer most remote from the light-incident surface 1A are formed to satisfy the relation σ2>σk>(α1, σ3). Moreover, such excellent recording and overwrite characteristics are also achievable to a laser wavelength shorter than for DVD in recording or reproduction.

[Study of Range in Thermal Conductivity]

Examined next is a range of thermal conductivity for the first protective film 2, the interface film 3, the second protective film 5, and the third protective film 6, that satisfy the relation σ2>σk>(σ1, σ3) to achieve excellent recording and overwrite characteristics.

Examined first is a range of the thermal conductivity σ2 for the second protective film 5.

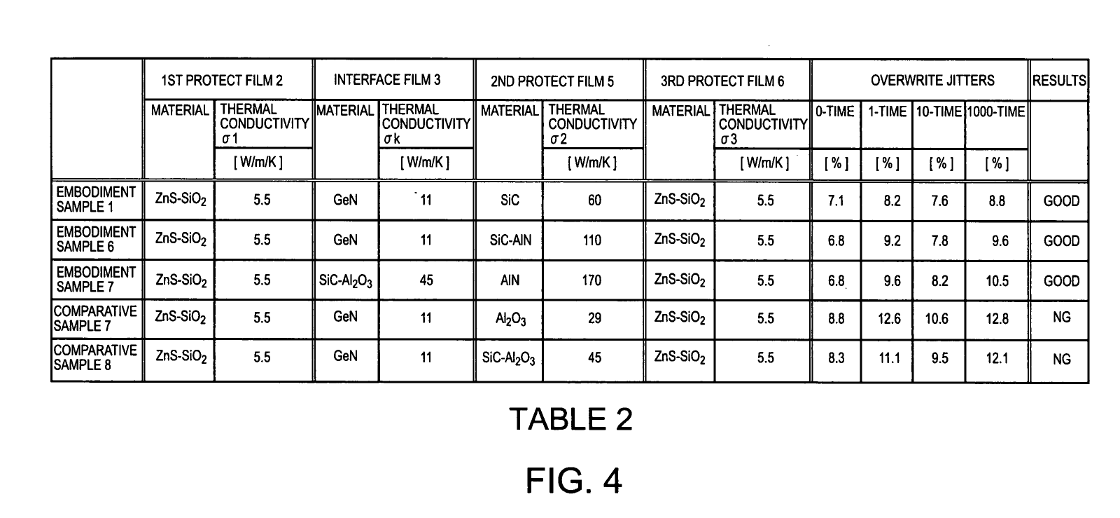

Shown in Table 2 of FIG. 4 are measured results of the embodiment sample 1 discussed above, and also new embodiment samples 6 and 7 and new comparative samples 7 and 8 of the optical storage medium D (which will be discussed later), measured in the same way as the embodiment sample 1.

The maximum allowable jitter level in this evaluation is 11.0% at or below which a higher reproduction-compatibility margin is taken. Reproduction compatibility means reproducible at several types of optical storage media reproducing apparatus.

As shown in Table 2 of FIG. 4, the embodiment sample 1 exhibited the jitter levels below 11.0% in all of the 0-, 1-, 10-, and 1000-time overwriting, thus excellent in the recording and overwrite characteristics.

### Embodiment Sample 6

The optical storage medium D in the embodiment sample 6 was identical to that of the embodiment sample 1 except for the second protective film 5 formed with a mixture of SiC—AlN at an optimum film thickness.

Results in thermal conductivity in the embodiment sample 6, different from the embodiment sample 1, were 110 W/m/K in thermal conductivity σ2 of the second protective film 5.

Other measured results were: 6.8%, 9.2%, 7.8% and 9.6% in the 0-, 1-, 10-, and 1000-time overwriting, respectively, below 11.0%, excellent in the recording and overwrite characteristics.

### Embodiment Sample 7

The optical storage medium D in the embodiment sample 7 was identical to that of the embodiment sample 1 except for the interface film 3 formed with a target of SiC—Al₂O₃ at an optimum film thickness and the second protective film 5 formed with a target of AlN at an optimum film thickness.

Measured results in thermal conductivity in the embodiment sample 7, different from the embodiment sample 1, were 45 W/m/K in thermal conductivity σk of the interface film 3 and 170 W/m/K in thermal conductivity σ2 of the second protective film 5.

Other measured results were: 6.8%, 9.60%, 8.20% and 10.50% in the 0-, 1-, 10-, and 1000-time overwriting, respectively, below 13.0%, excellent in the recording and overwrite characteristics.

### Comparative Sample 7

The optical storage medium D in the comparative sample 7 was identical to that of the embodiment sample 1 except for the second protective film 5 formed with a target of Al₂O₃ at an optimum film thickness.

Measured results in thermal conductivity in the comparative sample 7, different from the embodiment sample 1, were 29 W/m/K in thermal conductivity σ2 of the second protective film 5.

Other measured results were: 8.8%, 12.6% (over 11.0%), 10.6% and 12.8% (over 11.0%), in the 0-, 1-, 10-, and 1000-time overwriting, respectively, poor in the overwrite characteristics.

### Comparative Sample 8

The optical storage medium D in the comparative sample 8 was identical to that of the embodiment sample 1 except for the second protective film 5 formed with a target of SiC—Al₂O₃ at an optimum film thickness.

Measured results in thermal conductivity in the comparative sample 8, different from the embodiment sample 1, were 45 W/m/K in thermal conductivity σ2 of the second protective film 5.

Other measured results were: 8.3%, 11.1% (over 11.0%), 9.5% and 12.1% (over 11.0%), in the 0-, 1-, 10-, and 1000-time overwriting, respectively, poor in the overwrite characteristics.

Table 2 in FIG. 4 teaches that a feasible range of the thermal conductivity σ2 for the second protective film 5 is 50 W/m/K or higher but below 180 W/m/K. The thermal conductivity σ2 below 50 W/m/K prevents the semi-transparent recording film 4 from giving heat off well and hence cannot cancel the overwrite distortion, thus causing poor overwrite characteristics in the 1-time overwriting. In contrast, the thermal conductivity σ2 of 180 W/m/K or higher prevents the semi-transparent recording film 4 from keeping heat well when exposed to a laser beam L in recording, thus causing formation of imperfect recorded marks with lower signal intensity.

Examined next is a range of the thermal conductivity σk for the interface film 3.

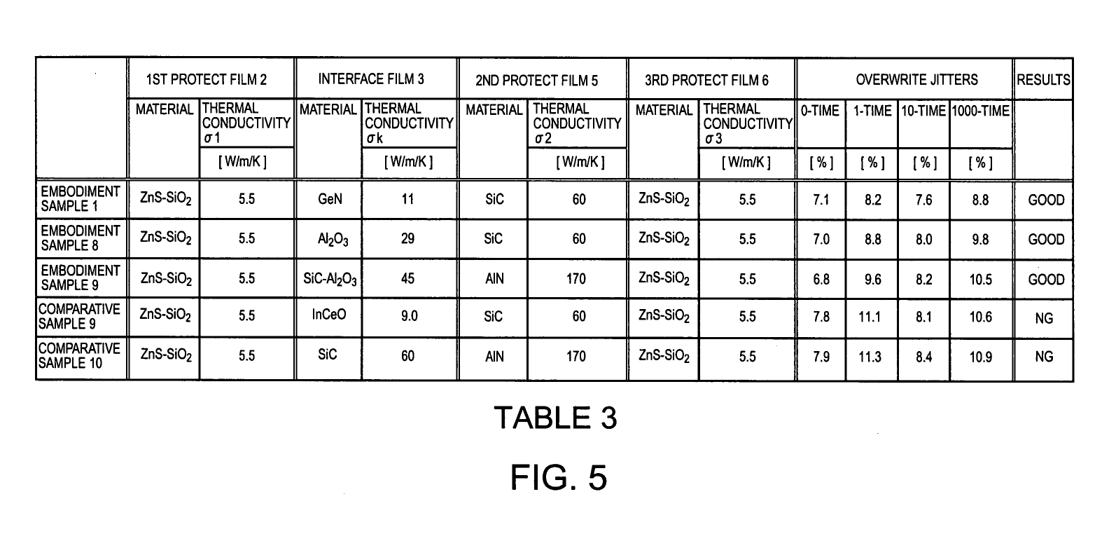

Shown in Table 3 of FIG. 5 are measured results of the embodiment sample 1 discussed above, and also new embodiment samples 8 and 9 and new comparative samples 9 and 10 of the optical storage medium D (which will be discussed later), measured in the same way as the embodiment sample 1.

As shown in Table 3 of FIG. 5, the embodiment sample 1 exhibited the jitter level below 11.0% in all of the 0-, 1-, 10-, and 1000-time overwriting, thus excellent in the recording and overwrite characteristics.

### Embodiment Sample 8

The optical storage medium D in the embodiment sample 8 was identical to that of the embodiment sample 1 except for the interface film 3 formed with a target of Al₂O₃ at an optimum film thickness.

Measured results in thermal conductivity in the embodiment sample 8, different from the embodiment sample 1, were 29 W/m/K in thermal conductivity σk of the interface film 3.

Other measured results were: 7.0%, 8.8%, 8.0% and 9.8% in the 0-, 1-, 10-, and 1000-time overwriting, respectively, below 11.0%, excellent in the recording and overwrite characteristics.

### Embodiment Sample 9

The optical storage medium D in the embodiment sample 9 was identical to that of the embodiment sample 1 except for the interface film 3 formed with a target of SiC—Al₂O₃ at an optimum film thickness and the second protective film 5 formed with a target of AlN at an optimum film thickness.

Measured results in thermal conductivity in the embodiment sample 9, different from the embodiment sample 1, were 45 W/m/K in thermal conductivity σk of the interface film 3 and 170 W/m/K in thermal conductivity σ2 of the second protective film 5.

Other measured results were: 6.8%, 9.6%, 8.2% and 10.5% in the 0-, 1-, 10-, and 1000-time overwriting, respectively, below 11.0%, excellent in the recording and overwrite characteristics.

### Comparative Sample 9

The optical storage medium D in the comparative sample 9 was identical to that of the embodiment sample 1 except for the interface film 3 formed with a target of InCeO at an optimum film thickness.

Measured results in thermal conductivity in the comparative sample 9, different from the embodiment sample 1, were 9.0 W/m/K in thermal conductivity σk of the interface film 3.

Other measured results were: 7.8%, 11.1% (over 11.0%), 8.1% and 10.6%, in the 0-, 1-, 10-, and 1000-time overwriting, respectively, poor in the overwrite characteristics.

### Comparative Sample 10

The optical storage medium D in the comparative sample 10 was identical to that of the embodiment sample 1 except for the interface film 3 formed with a target of SiC at an optimum film thickness and the second protective film 5 formed with a target of AlN at an optimum film thickness.

Measured results in thermal conductivity in the comparative sample 10, different from the embodiment sample 1, were 60 W/m/K in thermal conductivity σk of the interface film 3 and 170 W/m/K in thermal conductivity σ2 of the second protective film 5.

Other measured results were: 7.9%, 11.3% (over 11.0%), 8.4% and 10.9%, in the 0-, 1-, 10-, and 1000-time overwriting, respectively, poor in the overwrite characteristics.

Table 3 in FIG. 5 teaches that a feasible range of the thermal conductivity σk for the interface film 3 is 10 W/m/K or higher but below 50 W/m/K. The thermal conductivity σk of 10 W/m/K or higher promotes cooling the semi-transparent reflective film 7 and hence acceptable recorded marks being formed, thus offering excellent recording characteristics. In contrast, the thermal conductivity σk below 50 W/m/K is lower than that of the second protective film 4, thus offering excellent overwrite characteristics.

On the other hand, the thermal conductivity σk below 10 W/m/K prevents the semi-transparent recording film 4 from being cooled well, thus suffering lower signal intensity. In contrast, the thermal conductivity σk of 50 W/m/K or higher prevents the semi-transparent recording film 4 from keeping heat well when exposed to a laser beam L in recording, thus suffering lower signal intensity.

Accordingly, the thermal conductivity σk below 10 W/m/K or of 50 W/m/K or higher causes that the semi-transparent recording film 4 cannot keep heat well and then give it off well in a balanced manner and hence cannot cancel the overwrite distortion, thus suffering jitters higher than 11.0% in the 1-time overwriting.

Examined next is a range of the thermal conductivity σ1 for the first protective film 2.

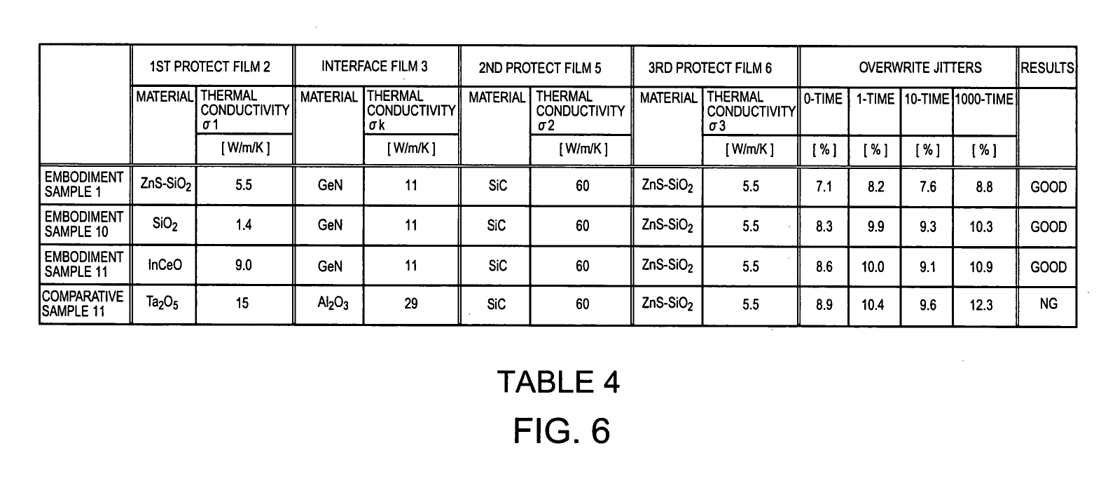

Shown in Table 4 of FIG. 6 are measured results of the embodiment sample 1 discussed above, and also new embodiment samples 10 and 11 and a new comparative sample 11 of the optical storage medium D (which will be discussed later), measured in the same way as the embodiment sample 1.

As shown in Table 4 of FIG. 6, the embodiment sample 1 exhibited the jitter level below 11.0% in all of the 0-, 1-, 10-, and 1000-time overwriting, thus excellent in the recording and overwrite characteristics.

### Embodiment Sample 10

The optical storage medium D in the embodiment sample 10 was identical to that of the embodiment sample 1 except for the first protective film 2 formed with a target of SiO₂ at an optimum film thickness.

Measured results in thermal conductivity in the embodiment sample 10, different from the embodiment sample 1, were 1.4 W/m/K in thermal conductivity σ1 of the first protective film 2.

Other measured results were: 8.3%, 9.9%, 9.3% and 10.3% in the 0-, 1-, 10-, and 1000-time overwriting, respectively, below 11.0%, excellent in the recording and overwrite characteristics.

### Embodiment Sample 11

The optical storage medium D in the embodiment sample 11 was identical to that of the embodiment sample 1 except for the second protective film 5 formed with a target of InCeO an optimum film thickness.

Measured results in thermal conductivity in the embodiment sample 11, different from the embodiment sample 1, were 9.0 W/m/K in thermal conductivity σ1 of the first protective film 2.

Other measured results were: 8.6%, 10.0%, 9.1% and 10.9% in the 0-, 1-, 10-, and 1000-time overwriting, respectively, below 11.0%, excellent in the recording and overwrite characteristics.

### Comparative Sample 11

The optical storage medium D in the comparative sample 11 was identical to that of the embodiment sample 1 except for the first protective film 2 formed with a target of Ta₂O₅ at an optimum film thickness and the interface film 3 formed with a target of Al₂O₃ at an optimum film thickness.

Measured results in thermal conductivity in the comparative sample 11, different from the embodiment sample 1, were 15 W/m/K in thermal conductivity σ1 of the first protective film 2 and 29 W/m/K in the thermal conductivity σk of the interface film 3.

Other measured results were: 8.9%, 10.4%, 9.6% and 12.3% (over 11.0%), in the 0-, 1-, 10-, and 1000-time overwriting, respectively, poor in the overwrite characteristics.

Table 4 in FIG. 6 teaches that a feasible range of the thermal conductivity σ1 for the first protective film 2 is below 10 W/m/K. The thermal conductivity σ1 of 10 W/m/K or higher prevents the semi-transparent recording film 4 from keeping heat well, thus causing insufficient erasure of already formed recorded marks in overwriting, and repetition of overwriting causing poor overwrite characteristics.

Examined next is a range of the thermal conductivity σ3 for the third protective film 6.

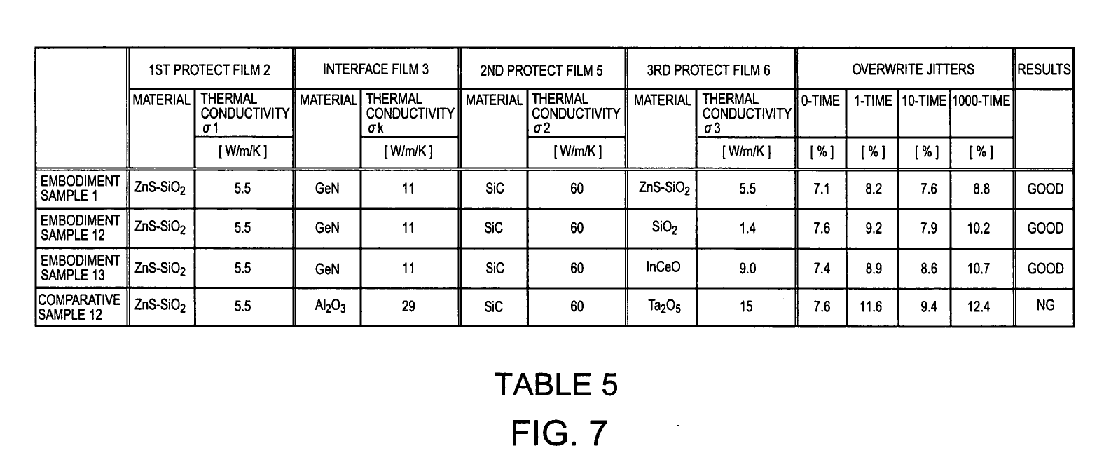

Shown in Table 5 of FIG. 7 are measured results of the embodiment sample 1 discussed above, and also new embodiment samples 12 and 13 and a new comparative sample 12 of the optical storage medium D (which will be discussed later), measured in the same way as the embodiment sample 1.

As shown in Table 5 of FIG. 7, the embodiment sample 1 exhibited the jitter level below 11.0% in all of the 0-, 1-, 10-, and 1000-time overwriting, thus excellent in the recording and overwrite characteristics.

### Embodiment Sample 12

The optical storage medium D in the embodiment sample 12 was identical to that of the embodiment sample 1 except for the third protective film 6 formed with a target of SiO₂ at an optimum film thickness.

Measured results in thermal conductivity in the embodiment sample 12, different from the embodiment sample 1, were 1.4 W/m/K in thermal conductivity σ3 of the third protective film 6.

Other measured results were: 7.6%, 9.2%, 7.9% and 10.2% in the 0-, 1-, 10-, and 1000-time overwriting, respectively, below 11.0%, excellent in the recording and overwrite characteristics.

### Embodiment Sample 13

The optical storage medium D in the embodiment sample 13 was identical to that of the embodiment sample 1 except for the third protective film 6 formed with a target of InCeO at an optimum film thickness.

Measured results in thermal conductivity in the embodiment sample 13, different from the embodiment sample 1, were 9.0 W/m/K in thermal conductivity σ3 of the third protective film 6.

Other measured results were: 7.4%, 8.9%, 8.6% and 10.7% in the 0-, 1-, 10-, and 1000-time overwriting, respectively, below 11.0%, excellent in the recording and overwrite characteristics.

### Comparative Sample 12

The optical storage medium D in the comparative sample 12 was identical to that of the embodiment sample 1 except for the third protective film 6 formed with a target of Ta₂O₅ at an optimum film thickness and the interface film 3 formed with a target of Al₂O₃ at an optimum film thickness.

Measured results in thermal conductivity in the comparative sample 12, different from the embodiment sample 1, were 15 W/m/K in thermal conductivity σ3 of the third protective film 6 and 29 W/m/K in thermal conductivity σk of the interface film 3.

Other measured results were: 7.6%, 11.6% (over 11.0%), 9.4% and 12.4% (over 11.0%), in the 0-, 1-, 10-, and 1000-time overwriting, respectively, poor in the overwrite characteristics.

Table 5 in FIG. 7 teaches that a feasible range of the thermal conductivity σ3 for the third protective film 6 is below 10 W/m/K. The thermal conductivity σ3 of 10 W/m/K or higher prevents the semi-transparent recording film 4 from keeping heat well when exposed to laser beam L in recording, thus the heat being given off to the semi-transparent reflective film 7. Accordingly, the semi-transparent recording film 4 cannot keep heat well and then give it off well in a balanced manner and hence cannot cancel the overwrite distortion, thus suffering poor overwrite characteristics in the 1-time overwriting.

As shown in Table 1 of FIG. 3, the optical storage medium D produced, like the embodiment sample 1, as having the first and third protective films 2 and 6 each made of a material including at least either ZnS or SiO₂, the interface film 3 made of a material including GeN as the major component, and the second protective film 5 made of a material including SiC as the major component, generates jitters below 9.0% in all of the 0-, 1-, 10-, and 1000-time overwriting, thus exhibiting excellent recording and overwrite characteristics.

As disclosed above in detail, the present invention provides a multilayer phase-change optical storage medium having two or more of composite layers, with higher transmittance to the composite layer closer or closest to the light-incident surface of the medium, thus exhibiting excellent recording and reproduction characteristics.

What is claimed is:

1. An optical storage medium comprising:
a substrate having a first surface and an opposite second surface, light being incident via the first surface in recording or reproduction; and
at least two composite layers formed on the second surface of the substrate, each composite layer having at least a recording film,
wherein at least one composite layer, except a composite layer farther or farthest from the first surface of the substrate, has at least a first protective film, an interface film, a semi-transparent recording film, a second protective film, a third protective film, and a semi-transparent reflective film formed in order when viewed from the substrate, the semi-transparent reflective film having a thickness below 10 nm, the first protective film, the interface film, the second protective film, and the third protective film having a relation σ2>σk>σ1>σ3 in which σ1, σk, σ2, and σ3 denote thermal conductivity of the first protective film, the interface film, the second protective film, and the third protective film, respectively.

2. The optical storage medium according to claim 1, wherein the thermal conductivity σ1 of the first protective film is below 10 W/m/K, the thermal conductivity σk of the interface film is 10 W/m/K or higher but below 50 W/m/K, the thermal conductivity σ2 of the second protective film is 50 W/m/K or higher but below 180 W/m/K, and the thermal conductivity σ3 of the third protective film is below 10 W/m/K.

3. The optical storage medium according to claim 1, wherein the first and third protective films are made of a material including at least either ZnS or SiO₂, the interface film is made of a material including GeN as a major component having a percentage of 50% or higher in the material, and the second protective film is made of a material including SiC as the major component.
